(19) United States
(12) Patent Application Publication
(10) Pub. No.: US 2004/0092222 A1
(43) Pub. Date: May 13, 2004

(54) Stationary head for a disc-type coin processing device having a solid lubricant disposed thereon

(76) Inventors: Bogdan Kowalczyk, Bloomingdale, IL (US); Mark A. Fladeland, Bolingbrook, IL (US)

Correspondence Address: JENKENS & GILCHRIST, P.C., 225 WEST WASHINGTON, SUITE 2600, CHICAGO, IL, 60606, US

(21) Appl. No.: 10/697,429

(22) Filed: Oct. 29, 2003

Related U.S. Application Data
(60) Provisional application No. 60/424,523, filed on Nov. 7, 2002.

(51) Int. Cl. G07D 3/00

(52) U.S. Cl. 453/12

(57) ABSTRACT

A disc-type coin processing device for processing a plurality of coins is disclosed according to one embodiment of the present invention. The coin processing device includes a rotatable disc that imparts motion to the plurality of coins and a stationary head, which has a lower surface generally parallel to and spaced slightly away from the rotatable disc. The lower surface of the stationary head has a plurality of shaped regions that control the movement of the coins. A solid lubricant is disposed on the lower surface of the sorting head.

### CROSS-REFERENCE To RELATED APPLICATION

This application claims the benefit of U.S. Provisional Patent Application Serial No. 60/424,523, entitled “Stationary Head for a Disc-Type Coin Processing Device Having a Solid Lubricant Disposed Thereon,” which was filed on Nov. 7, 2002 and is incorporated herein by reference in its entirety.

### FIELD OF THE INVENTION

The present invention relates generally to coin processing devices and, more particularly, to a coating process for increasing the hardness of a sorting head for use with a disc-type coin processing device.

### BACKGROUND OF THE INVENTION

Disc-type coin sorters typically include a resilient pad (disposed on a rotating disc) that rotates beneath a stationary sorting head having a lower surface positioned parallel to the upper surface of the resilient pad and spaced slightly therefrom. The rotating, resilient pad presses coins upward against the sorting head as the pad rotates. The lower surface of sorting head includes numerous shaped regions including exit channels for manipulating and controlling the movement of the coins. As coins are discharged from the sorting head via the exit channels, the sorted coins follow respective coin paths to sorted coin receptacles where the sorted coins are stored. Other coin processing devices, such as rail sorters, use a stationary head and rotating disc to align coins along a common axis, but not to sort the coins.

As the coins rotate on the resilient pad and are manipulated by the various shaped regions on the underside of the stationary sorting head, the coins traveling at high rates of speed impact the various shaped regions formed in the underside of the sorting head. For example, the resilient pad may be rotating anywhere between about 250 r.p.m. and about 400 r.p.m. resulting in coins traveling at speeds up to 250 inches per second. While the stationary sorting head is constructed of metal or other rigid material, the impact of the coins against the various shaped regions formed in the sorting head tends to wear away at and erode the sorting head. Specifically, the areas of the sorting head impacting the coins tend to experience significant degradation over time due to abrasion. Most surfaces of the underside of the sorting head contacted by coins, in addition to the various walls, experience substantial abrasion by the many coins that move along the underside of the sorting head at high velocities. This degradation of the sorting head can impact the accuracy of the coin sorting process resulting in the need to replace the coin sorting system's sorting head.

### SUMMARY OF THE INVENTION

A disc-type coin processing device for processing a plurality of coins is disclosed according to one embodiment of the present invention. The coin processing device includes a rotatable disc that imparts motion to the plurality of coins and a stationary head, which has a lower surface generally parallel to and spaced slightly away from the rotatable disc. The lower surface of the stationary head has a plurality of shaped regions that control the movement of the coins. A solid lubricant is disposed on the lower surface of the sorting head.

The above summary of the present invention is not intended to represent each embodiment, or every aspect, of the present invention. Additional features and benefits of the present invention are apparent from the detailed description, figures, and embodiments set forth below.

### BRIEF DESCRIPTION OF THE DRAWINGS

FIG. 1 is a perspective view of a coin processing system having a stationary sorting head according to one embodiment of the present invention.

FIG. 2 is a perspective view of a disc-type coin processing unit for use with the coin processing system of FIG. 1, according to one embodiment of the present invention, with portions thereof broken away to show the internal structure.

FIG. 3 is an enlarged bottom view of a sorting head for use with the coin processing unit of FIG. 2.

FIG. 4 enlarged bottom view of a sorting head according to one embodiment of the present invention for use with the coin processing unit of FIG. 2

FIG. 5 is a cross-sectional view of the sorting head taken along line 5-5 in FIG. 4.

FIG. 6 is a flow chart showing a method for manufacturing a sorting head according to one embodiment of the present invention.

While the invention is susceptible to various modifications and alternative forms, specific embodiments are shown by way of example in the drawings and are described in detail herein. It should be understood, however, that the invention is not intended to be limited to the particular forms disclosed.

### DETAILED DESCRIPTION OF THE ILLUSTRATED EMBODIMENTS

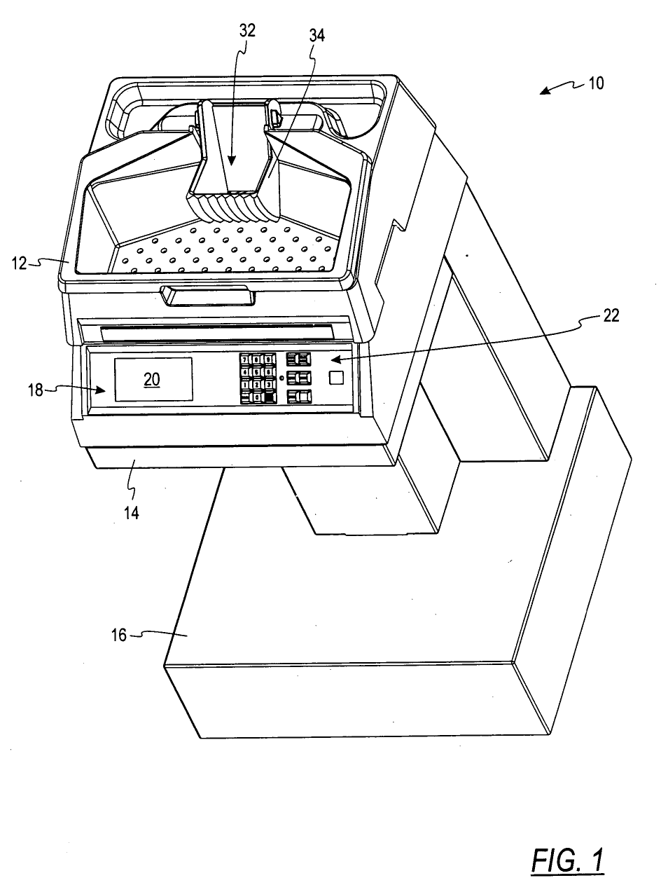

Turning now to the drawings and referring first to FIG. 1, a coin processing system 10 having a pivoting coin input tray 12 is shown. The coin tray 12 holds coins prior to inputting some or all of the coins in the coin tray 12 to the coin processing system 10. The coin tray 12 transfers the coins by pivoting upward causing coins deposited therein to move, under the force of gravity, to a sorting mechanism (not shown) disposed within a cabinet 14 via a funnel 32 formed by a coin chute 34. The sorting mechanism discharges sorted coins to a plurality of coin bags (not shown), or other coin receptacles. Coin bags may be suspended from the cabinet 14 while the bottoms of the bags rest upon a platform 16.

An operator interface 18 interacts with a controller (not shown) of the coin processing system 10. The controller determines the coin totals during sorting, controls the termination of coin sorting (e.g., when a predetermined number of coins have been transferred to a coin bag), and calculates pertinent data regarding the sorted coins. The operator interface includes a display 20 for displaying information to an operator of the coin processing system 10 and a keypad 22 for receiving input from an operator of the coin processing system 10. Input from an operator of the coin sorter 10 can include selection of predefined modes of operation, instructions for defining modes of operation, requests for certain output to be displayed on the display 20 and/or an optional printer (now shown), identification information such as an identification code for identifying particular transactions or batches of coins, etc. According to an alternative embodiment, the operator interface 18 comprises a touch screen type display/interface.

During consecutive batch sorting operations, an operator places a batch of coins into the coin tray 12 and optionally inputs an identification number along with any additional data regarding the batch via the interface 18. The operator then transfers the coins within the coin tray 12 to the sorting mechanism. While the batch of coins are being sorted, the operator can place a next batch of coins into the coin tray 12 and optionally enter data corresponding to the next batch.

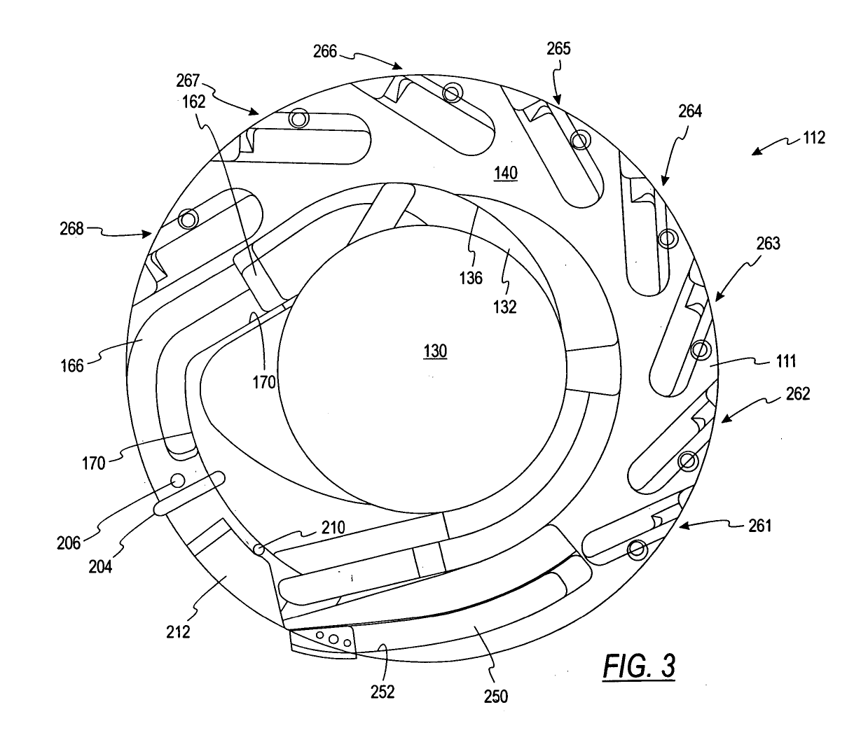

Referring now to FIG. 3, a disc-type coin processing unit 100 is shown that can be used in the coin processing system 10 of FIG. 1 according to one embodiment of the present invention. The coin processing unit 100 includes a hopper 110 for receiving coins of mixed denominations via the funnel 32 of the coin chute 34, and feeds the coins through a central opening in an annular, stationary sorting head 112. As the coins pass through this opening, they are deposited on the top surface of a rotatable disc 114. This rotatable disc 114 is mounted for rotation on a shaft (not shown) and driven by a motor 116. The disc 114 typically comprises a resilient pad 118, made of a resilient rubber or polymeric material, bonded to the top surface of a solid disc 120. The solid disc 120 is often made of metal, but it can also be made of a rigid polymeric material.

According to one embodiment, coins are initially deposited by a user in the coin tray 12 (FIG. 1) disposed above the coin processing unit 100. Coins flow through down the funnel 32 of the coin chute 34 under the force of gravity into the hopper 10 when the user lifts the coin tray 12.

As the disc 114 is rotated, the coins deposited on the resilient pad 118 tend to slide outwardly over the surface of the pad 118 due to centrifugal force. As the coins move outwardly, those coins which are lying flat on the pad 118 enter the gap between the surface of the pad 118 and the sorting head 112 because the underside of the inner periphery of the sorting head 112 is spaced above the pad 118 by a distance which is about the same as the thickness of the thickest coin. As is further described below, the sorting head 112 includes a plurality of coin-directing channels, or shaped regions, for manipulating the movement of the coins from an entry area to a plurality of exit channels where the coins are discharged. The coin exit channels may sort the coins into their respective denominations by discharging the coins from exit channels in the sorting head 112 corresponding to their denominations.

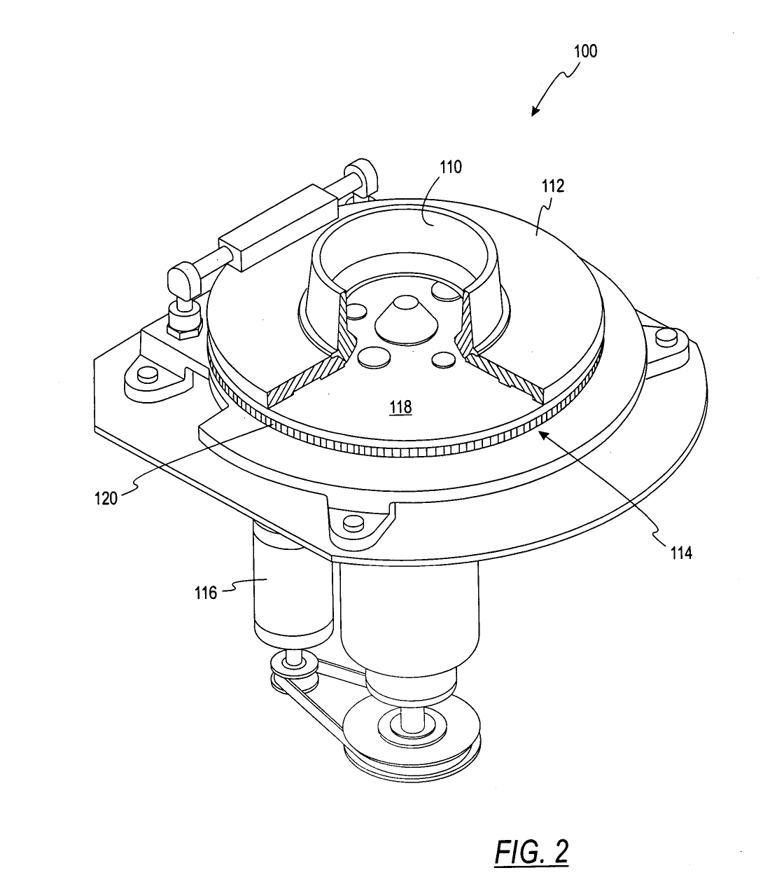

Referring now to FIG. 3, the underside 111 of the sorting head 112 is shown. The coin sets for any given country are sorted by the sorting head 112 due to variations in the diameter size. The coins circulate between the stationary sorting head 112 and the rotating pad 118 (FIG. 2) on the rotatable disc 114 (FIG. 2). The coins are deposited on the pad 118 via a central opening 130 and initially enter the entry channel 132 formed in the underside of the sorting head 112. It should be keep in mind that the circulation of the coins in FIG. 3 appears counterclockwise as FIG. 2 is a view of the underside of the sorting head 112.

An outer wall 136 of the entry channel 132 divides the entry channel 132 from the lowermost surface 140 of the sorting head 112. The lowermost surface 140 is preferably spaced from the pad 118 by a distance that is slightly less than the thickness of the thinnest coins. Consequently, the initial outward radial movement of all the coins is terminated when the coins engage the outer wall 136, although the coins continue to move more circumferentially along the wall 136 (in the counterclockwise directed as viewed in FIG. 3) by the rotational movement imparted to the coins by the pad 118 of the rotatable disc 114.

As the pad 118 continues to rotates, those coins that were initially aligned along the wall 136 move across the ramp 162 leading to the queuing channel 166 for aligning the innermost edge of each coin along an inner queuing wall 170. The coins are gripped between the queuing channel 166 and the pad 118 as the coins are rotated through the queuing channel 166. The coins, which were initially aligned with the outer wall 136 of the entry channel 130 as the coins move across the ramp 162 and into the queuing channel 166, are rotated into engagement with inner queuing wall 170. As the pad 118 continues to rotate, the coins which are being positively driven by the pad move through the queuing channel 166 along the queuing wall 170 passed a trigger sensor 206 and a discrimination sensor 204 for discriminating between valid and invalid coins. In other embodiments, the discrimination sensor also determines the denomination of the coins. The trigger sensors 206 sends a signal to the discrimination sensor 204 that a coin is approaching.

Coins determined to be invalid are rejected by a diverting pin 210 which is lowered and impacts an invalid coin to redirect the invalid coin to the reject channel 212 that guides the rejected coins to a reject chute (not shown) for directing the coin back to the user. The diverting pin 210 remains in its home, or nondiverting position, until an invalid coin is detected. Those coins not diverted into the reject channel 212 continue along inner queuing wall 170 to the gauging region 250. The inner queuing wall 170 terminates just downstream of the reject channel 212; thus, the coins no longer abut the inner queuing wall 170 at this point and the queuing channel 166 terminates. The radial position of the coins is maintained, because the coins remain under pad pressure, until the coins contact an outer wall 252 of the gauging region 250.

The gauging wall 252 aligns the coins along a common radius as the coins approach a series of coin exit channels 261-268 that discharge coins of different denominations. The first exit channel 261 is dedicated to the smallest coin to be sorted (e.g., the dime in the U.S. coin set). Beyond the first exit channel 261, the sorting head 112 shown in FIG. 3 forms seven more exit channels 261-268 that discharge coins of different denominations at different circumferential locations around the periphery of the sorting head 112. Thus, the exit channels 261-268 are spaced circumferentially around the outer periphery of the sorting head 112 with the innermost edges of successive channels located progressively closer to the center of the sorting head 112 so that coins are discharged in the order of increasing diameter. The number of exit channels can vary according to alternative embodiments of the present invention.

The innermost edges of the exit channels 261-268 are positioned so that the inner edge of a coin of only one particular denomination can enter each channel 261-268. The coins of all other denominations reaching a given exit channel extend inwardly beyond the innermost edge of that particular exit channel so that those coins cannot enter the channel and, therefore, continue on to the next exit channel under the circumferential movement imparted on them by the pad 118. To maintain a constant radial position of the coins, the pad 118 continues to exert pressure on the coins as they move between successive exit channels 261-268.

Further details of the operation of the sorting head 112 shown in FIG. 3 are disclosed in U.S. Patent Application Publication No. 2003/0168309A1, entitled “Disc-Type Coin Processing Device Having Improved Coin Discrimination System,” which was filed on Mar. 11, 2002 and is incorporated herein by reference in its entirety. While a coin sorter having exit channels sized for particular coins to be sorter has been shown and described, the present invention can be used in connection with other types of sorting heads of disc-type coin sorters such as a programmable coin sorters, which sort coins independent of the diameter of the coins to be sorter. A programmable coin sorter is disclosed in U.S. Patent Application Publication No. 2003/0168309A1, incorporated by reference above.

As discussed in the Background Section, the various regions formed in the underside of the sorting head 112 such as the outer wall 136 of the entry channel 132, the ramp 162, the inner queuing wall 170, the reject channel 212, the outer wall 252 of the gauging, and the exit channels 261-268, for example, tend to degrade over time due to the repeated impact by the coins being processed, which are traveling at high velocities. Further, the surfaces of the underside of the sorting head 112 contacted by the coins, in addition to the various walls, are subjected to substantial abrasion by the many coins that move along the underside of the sorting head 112 at high velocities.

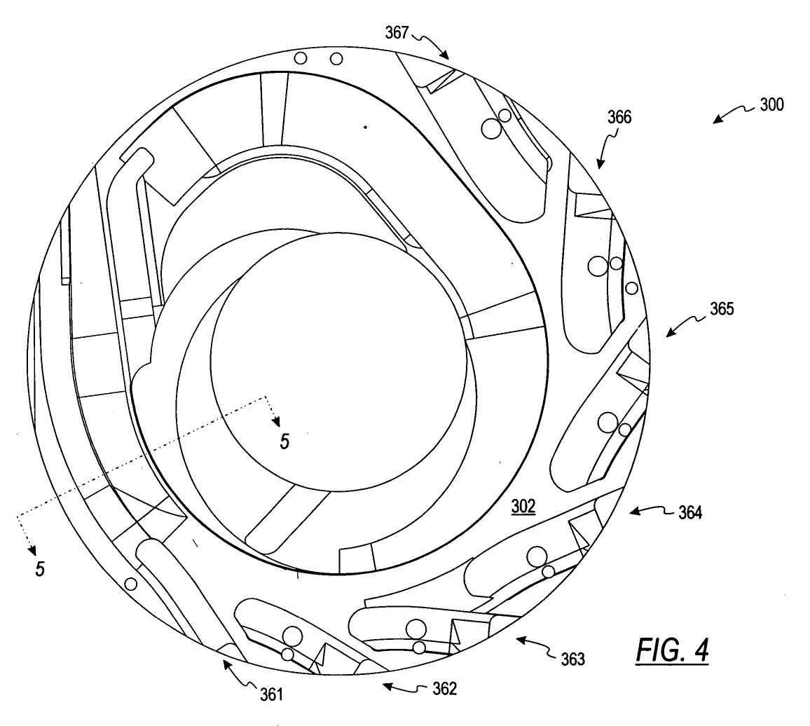

Referring to FIGS. 4 and 5, a sorting head 300 is illustrated according to one embodiment of the present invention. Like the sorting head illustrated in FIG. 3, the sorting head 300 includes a plurality of shaped regions including coin exit channels 361-367 for controlling the movement of coins. To guard against the degradation of the sorting head 300 due to coin impact and abrasion, an underside 302 of the sorting head 300 is mechanically and/or chemically treated to improve the resistance of the sorting head 300 to wear and tear associated with coin impact and abrasion. One type of material that may be applied to the underside of the sorting head is a solid lubricant 320. According to one embodiment of the present invention, a coating or layer of MicroBlue® is applied to the sorting head 300 to improve the resistance of the sorting head 300 to wear and tear associated with coin impact and abrasion. The MicroBlue® coating is a lubricating solid comprised of tungsten disulphide particles in lamellar form, and is commercially available from Material Technologies, Inc. of Rockford, Ill. The MicroBlue® coating improves sliding friction across the lower surface of the sorting head 300 to reduce the degradation of the lower surface due to impact and abrasion caused by coins moves across the lower surface of the sorting head at high velocities, which also reduces the galling of coins across the lower surface of the sorting head. The MicroBlue® coating is durable having an operating range of about −400° F. to about +1000° F. (about −240° C. to about +538° C.), and it can withstand load forces in excess of 300,000 pounds/in² (psi) (about 2,068 megapascals).

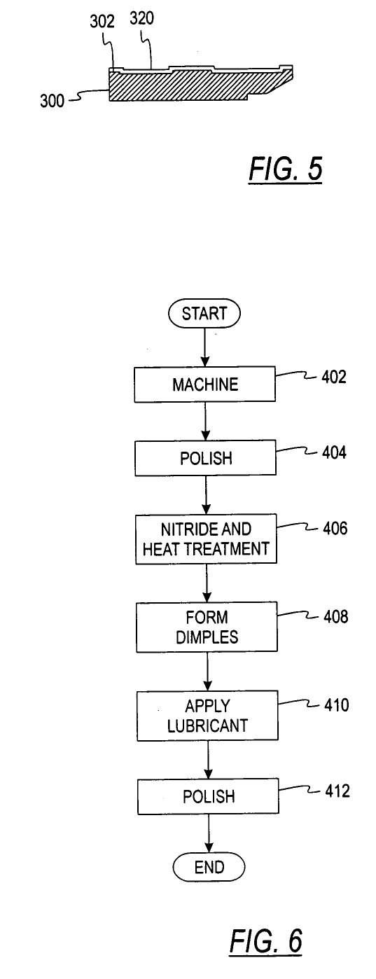

Referring now to FIG. 6, the manufacture of the sorting head 300 will be described according to one embodiment of the preset invention. Initially, at step 402, the sorting head 300 is machined from a rigid material using machining techniques known in the art. The sorting head 300 may be constructed of a steel alloy flat stock such as, for example, a 4140 Alloy Prehard steel or a Nitralloy 135 steel. The sorting head is constructed of other metals, steels, or steel alloys in various alternative embodiments of the present invention. The machined sorting head is then polished at step 404, and then undergoes a nitride and heat treatment process at step 406.

Next, a lubricant such as a MicroBlue® coating is applied. According to one embodiment of the present invention, the lubricant coating is applied via high velocity impingement, which results in a durable molecular/mechanical bond that is resistant to chipping, flaking, and peeling. At step 408, prior to the application of the lubricant coating, the lower surface of the sorting head is microscopically-modified to create a plurality of tiny pockets or dimples across the lower surface of the sorting head 300. The size of the pockets or dimples correspond to the size of the tungsten disulphide particles that comprises the MicroBlue® coating. At step 410, the lubricant is deposited on the surface of the sorting head. Because the material does not bond to itself and no binders are used in the process, the result is a substantially uniform coating that is that is about 1 micron thick or less. (The thickness of the solid lubricant coating 320 is exaggerated in FIG. 5.) The sorting head 300 is then polished again at step 412. The result of the above-described manufacturing process is a solid lubricant layer applied to the underside of the sorting head that lessens the degradation of the sorting head from coin impact and abrasion due to coins moving at high-velocities, which increases the life of the sorting head.

Thus far, the present invention has been described in connection with disc-type coin sorting devices. However, the present invention may be used in connection with other types of coin processing devices according to alternative embodiments of the present invention. For example, a solid lubrication may be applied to the lower surface of a stationary head for aligning coins for entry into another device such as a rail sorter, which is described in U.S. Pat. No. 5,382,191 and is incorporated herein by reference in its entirety.

While the invention is susceptible to various modifications and alternative forms, specific embodiments thereof are shown by way of example in the drawings and described in detail herein. It should be understood, however, that it is not intended to limit the invention to the particular forms disclosed, but on the contrary, the intention is to cover all modifications, equivalents, and alternatives falling within the spirit and scope of the invention as defined by the appended claims.

What is claimed is:

1. A disc-type coin processing device for processing a plurality of coins, comprising:
a rotatable disc for imparting motion to the plurality of coins; and
a stationary head having a lower surface generally parallel to and spaced slightly away from the rotatable disc, the lower surface having a plurality of shaped regions for controlling the movement of the coins, the lower surface having a solid lubricant disposed thereon.

2. The device of claim 1 wherein the solid lubricant comprises tungsten disulphide particles.

3. The device of claim 1 wherein the solid lubricant has a thickness of about one micron.

4. The device of claim 1 wherein the solid lubricant has a thickness of less than about one micron.

5. The device of claim 1 wherein the sorting head is constructed of a 4140 Alloy Prehard steel.

6. The device of claim 1 wherein the sorting head is constructed of a Nitralloy 135 steel.

7. A stationary head for a disc-type coin processing device, the stationary head comprising at least one surface having a solid lubricant disposed thereon.

8. The stationary head of claim 7 wherein the solid lubricant comprises tungsten disulphide particles.

9. The stationary head of claim 7 wherein the solid lubricant has a thickness of about one micron.

10. The stationary head of claim 7 wherein the solid lubricant has a thickness of less than about one micron.

11. The stationary head of claim 7 wherein the stationary head is constructed of a 4140 Alloy Prehard steel.

12. The stationary head of claim 7 wherein the stationary head is constructed of a Nitralloy 135 steel.

13. A method of processing coins, comprising;
receiving coins in a coin receiving region;
imparting motion to the coins with a rotatable disc; and
engaging the coins with a surface of a stationary sorting head coated with a solid lubricant while imparting motion.

14. The method of claim 13 further comprising sorting the received coins according to denomination.

15. The method of claim 14 wherein sorting comprising discharging coins from a plurality of coins exit channels formed in the surface of the sorting head.

16. A method of constructing a sorting head for a disc-type coin sorter, the method comprising:
providing generally disc-shaped metal object;
machining a plurality of shaped regions in a first surface of the object;
forming a plurality of dimples in the first surface of the object; and
depositing a solid lubricant on the first surface of the object.

17. The method of claim 16 comprising polishing the first surface of the object after machining.

18. The method of claim 16 comprising subjecting the object to a nitride and heat treatment process after machining.

19. The method of claim 17 wherein the sold lubricant comprises tungsten disulphide particles.

20. The method of claim 19 wherein the dimples are sized to corresponding to the tungsten disulphide particles.

21. The method of claim 16 comprising polishing the first surface of the object after depositing the solid lubricant.
